(19) United States
(12) Patent Application Publication
(10) Pub. No.: US 2016/0008837 A1
(43) Pub. Date: Jan. 14, 2016

(54) DEVICE FOR DISPENSING CRYOGENIC FLUID JETS, HAVING A FLEXIBLE PROTECTION CASING

(71) Applicant: L'AIR LIQUIDE, SOCIETE ANONYME POUR L'ETUDE ET L'EXPLOITATION DES PROCEDES GEORGES CLAUDE, Paris (FR)

(72) Inventors: Frédéric RICHARD, Parmain (FR); Jacques QUINTARD, Presles (FR); Charles TRUCHOT, Saint Nazaire (FR)

(21) Appl. No.: 14/772,930

(22) PCT Filed: Mar. 4, 2014
(86) PCT No.: PCT/FR2014/050469

§ 371 Date: Sep. 4, 2015

(30) Foreign Application Priority Data
Mar. 7, 2013 (FR) 1352051

(51) Int. Cl. B05B 13/04; C04B 41/53; C04B 41/72; B24C 1/00

(52) U.S. Cl. CPC B05B 13/0421; B24C 1/003; C04B 41/53; C04B 41/72

(57) ABSTRACT

The invention relates to a device for dispensing one or more jets (5) of high-pressure fluid at cryogenic temperature, comprising a nozzle-bearing tool (4) comprising one or more fluid distribution nozzles (6), and a movement system (2) for moving said nozzle bearing tool (4). According to the invention, the device further comprises at least one flexible protection casing (7) arranged around all or part of the movement system (2) that moves said nozzle bearing tool (4).

The invention relates to a device for dispensing jets of high-pressure fluid at cryogenic temperature and to a method implementing such a device to scour or de-scale the surface of a material, particularly to de-scale a concrete surface.

It is known practice to treat the surfaces of coated or non-coated materials, particularly to scour, de-scale or the like concrete, paint, etc., essentially using sand-blasting, ultra high pressure (UHP) water jets, sanders, jack hammers, bush hammers or even using a chemical process. A method and a device for treating the surface by spraying water is notably known from document EP-A-0200858.

However, the use of water is proscribed in certain applications, for example in nuclear environments, or with chemical products, because of the severe environmental constraints.

One alternative is to use one or more jets of high-pressure fluid at cryogenic temperatures, particularly liquid nitrogen, to scour or descale certain surfaces or coatings. During such an operation, three effects of each jet of liquid nitrogen combine, these being:
the mechanical effect of the jet, namely the impact of the pressure of the liquid nitrogen impinging on the substrate,
the cryogenic effect of the nitrogen in the liquid state, namely at a cryogenic temperature typically of below −130° C.,
the “blast effect” generated by the rapid warming of the liquid nitrogen upon contact with the ambient air as it transitions from the liquid phase to the gaseous phase which occupies a greater volume. Thus, one liter of liquid nitrogen vaporizes into 700 liters of gaseous nitrogen.

In certain applications, such as the descaling of concrete, it is mainly the “blast” effect of the liquid nitrogen that comes into play in order to accomplish the required work.

In that case, each jet of liquid nitrogen “bursts open” the surface of the concrete and blasts the constituents of the concrete in all directions.

Usually, the scouring or descaling of surfaces or coatings is performed by one or more jets of high-pressure fluid at cryogenic temperature, also referred to as jets of cryogenic fluid, generally at a temperature of below −100° C., preferably of between −130° C. and −160° C., and at a pressure of at least 300 bar, preferably of between 1000 and 5000 bar.

The jets of cryogenic fluid are distributed by one or more fluid distribution nozzles arranged on a nozzle bearing tool which is given a determined movement, preferably a rotary movement, the nozzle bearing tool being fluidically connected to the downstream end of a cryogenic fluid supply pipe.

In order to set the nozzle bearing tool in motion, the downstream portion supporting the downstream end of the cryogenic fluid supply pipe is given a determined movement, preferably a rotary movement, about the axis of the fixed upstream portion of said pipe.

In order to do that, a movement system that moves the nozzle bearing tool is arranged between the upstream portion and the downstream portion of pipe and acts on said downstream portion so as to give it said determined movement. Typically, the movement system that moves the nozzle bearing tool may comprise a motor collaborating with a fluid supply pipe notably via a rotary transmission shaft and a rotation mechanism, as proposed in document WO-A-2011/010030.

The cryogenic fluid jet distribution devices are also known from document WO-A-2010/133784, which discloses the arrangement of an extraction bell around the nozzle bearing tool of the device, and from document FR-A-2978925 which discloses the arrangement of a rigid housing around the movement system that moves the nozzle bearing tool.

Now, it has been found that scouring or descaling methods employing such cryogenic fluid jet distribution devices lose effectiveness over time. One of the reasons for this is the accelerated erosion of the cryogenic fluid distribution nozzles which is caused by the particles of scoured-off or scaled material blasted toward said nozzles.

In an attempt to alleviate these problems, document WO-A-2011/0151550 has proposed protecting at least part of the cryogenic fluid distribution nozzle or nozzles using a strong material of a hardness higher than that of the materials of which these nozzles are usually made.

More specifically, document WO-A-2011/0151550 teaches coating at least part of the cryogenic fluid distribution nozzle or nozzles with said resistant material or arranging a protective screen formed of said resistant material between the nozzle bearing tool and the treated surface of material.

However, this solution is not entirely satisfactory because there are a certain number of other problems underlying the loss of efficiency of the methods for descouring or descaling using jets of cryogenic fluid that it does not address.

Specifically, the inventors of the present invention have demonstrated that the loss of effectiveness of the scouring or descaling methods, particularly as far as the descaling of concrete is concerned, was due not only to the erosion of the cryogenic fluid distribution nozzle or nozzles but also to erosion of the movement system that moves the nozzle bearing tool.

Thus, during an operation in which concrete is descaled using high-pressure jets of liquid nitrogen at cryogenic temperature, it is found that particles of concrete are blasted at high speed toward the movement system that moves the nozzle bearing tool.

Concrete is made up of cement and aggregate. Under the effect of the high-pressure liquid nitrogen at cryogenic temperature the cement is pulverized and becomes dust. By contrast, the aggregate is broken up or cut and blasted notably toward the movement system that moves said tool. The hardness of the aggregate is of the order of 6 to 8 Mohs and is markedly higher than that of the cement, which is of the order of 2 to 3 Mohs.

Now, certain parts, components or constituent elements of the movement system that moves the nozzle bearing tool, such as the ball bearings or gears, are made of plastics materials and aluminum and may find themselves exposed to fragments of aggregate blasted during the concrete descaling operation.

Because the hardness of the plastics used, which is of the order of 3 to 4 Mohs, and that of aluminum, of the order of 2 to 3 Mohs, is lower than that of the aggregate blasted, this aggregate erodes and damages the exposed surfaces of the movement system that moves the nozzle bearing tool.

This results in disruptions to the movement conferred upon the nozzle bearing tool, leading to a loss of effectiveness of the method using the jets distributed by the nozzle bearing tool, and to accelerated wear of the movement system and an increased risk of the elements thereof breaking.

Furthermore, dust resulting from the pulverizing of the cement may enter the movement system that moves the nozzle bearing tool and seize the ball bearings or gears of said system.

Ultimately, it is necessary for the movement system, which is very expensive, to be replaced, and this has a negative impact on the productivity of the working installation.

The solution proposed in the prior art (WO-A-2011/0151550) consisting in coating the constituent elements of the movement system with a resistant material of greater hardness is not ideal because it significantly increases the cost of the movement system.

The other solution proposed in that same document of the prior art, which is to arrange a rigid screen opposite the movement system, said screen being formed of a resistant material of a hardness higher than that of the aggregate, is not conceivable either. This is because a large-sized rigid screen is needed to protect the movement system, because of the amplitude of movement of the nozzle bearing tool, and this considerably increases the bulk of the cryogenic fluid jet distribution device. Furthermore, there is a risk that such a screen will impede the movement of the downstream portion of the pipe and of the nozzle bearing tool. Furthermore, it is difficult to seal against dust with such a rigid screen.

The problem that needs to be resolved is therefore that of proposing a device for dispensing one or more jets of cryogenic fluid, particularly liquid nitrogen, to carry out a method for scouring or descaling a surface, notably a concrete surface, and that will enable the loss of effectiveness of said method as a result of the erosion and damage to the movement system that moves the nozzle bearing tool to be limited considerably or even avoided, and do so without significantly increasing the bulk of the device or impeding the movement conferred upon the nozzle bearing tool.

The solution of the invention is therefore a device for dispensing one or more jets of high-pressure fluid at cryogenic temperature, comprising a nozzle-bearing tool comprising one or more fluid distribution nozzles, and a movement system for moving said nozzle bearing tool, characterized in that it further comprises at least one flexible protection casing arranged around all or part of the movement system that moves said nozzle bearing tool.

Moreover, according to the embodiment considered, the invention may comprise one or more of the following features:
the flexible protection casing is also arranged around the nozzle bearing tool.
the device further comprises a fluid supply pipe comprising an upstream portion of axis XX and a downstream portion fluidically connected to the nozzle bearing tool, the movement system that moves the nozzle bearing tool being arranged between the upstream portion and the downstream portion of pipe and acting on said downstream portion so as to confer upon it a determined movement about the axis XX.
the at least one flexible protection casing is also arranged around all or part of the downstream portion of pipe.
the at least one flexible protection casing comprises a first open end situated level with the nozzle bearing tool or with the downstream portion of pipe and a second open end situated level with the movement system that moves said nozzle bearing tool or of the downstream portion of pipe.
the first open end is situated in the region of the nozzle bearing tool and the second open end is situated level with the movement system that moves said nozzle bearing tool.
the first open end is situated level with the downstream portion of pipe and the second open end is situated level with the movement system that moves said nozzle bearing tool.
the device further comprises securing means that fix the first end of the at least one flexible protection casing to the nozzle bearing tool or to the downstream portion of pipe and that fix the second end of the at least one protection casing to the movement system that moves said nozzle bearing tool or to the downstream portion of pipe, said securing means allowing at least one end of the flexible protection casing to be detached.
several flexible protection casings are superposed.
at least one flexible protection casing comprises a network of interlaced links forming chain-mail.
the links are of annular or oval shape, with external dimensions of between 3 and 4 mm and inside dimensions of between 2 and 3 mm.
said at least one flexible protection casing comprises a weave of filaments.
the flexible protection casing is formed completely or partly of a material that has a hardness of at least 7 Mohs, preferably at least 8 Mohs.
said at least one flexible protection casing is formed completely or partially of a material chosen from: a metallic material such as titanium or stainless steel, carbon fiber, ceramic composite fibers.
said at least one flexible protection casing is formed completely or partially from stainless steel of type 316L.
a woven or nonwoven material such as stainless steel wool is arranged in bulk between the flexible protective sleeve, the movement system and the downstream portion of pipe.

Another aspect of the invention relates to a method for scouring or de-scaling a surface that is to be treated, preferably a concrete surface, employing one or more jets (5) of high-pressure fluid at cryogenic temperature which are distributed by means of a device according to the invention.

Advantageously, the jet or jets of high-pressure fluid at cryogenic temperature are at a pressure of at least 300 bar, preferably of between 1000 and 5000 bar, and at a temperature of below −100° C., preferably of between −130° C. and −160° C.

For preference, the fluid used is liquid nitrogen.

The method of the invention is advantageously carried out for a scouring or descaling of concrete surface.

The invention will now be better understood from the following detailed description given with reference to the attached figures, among which:

FIG. 1 schematically depicts a cryogenic fluid jet distribution device without the invention, and

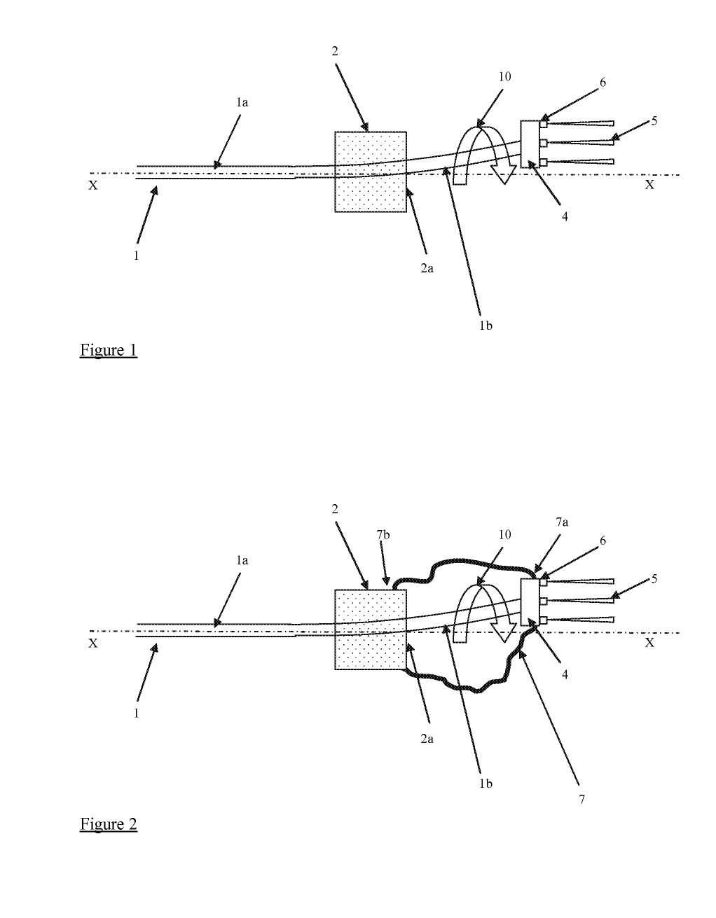

FIG. 2 schematically depicts a device according to one embodiment of the invention.

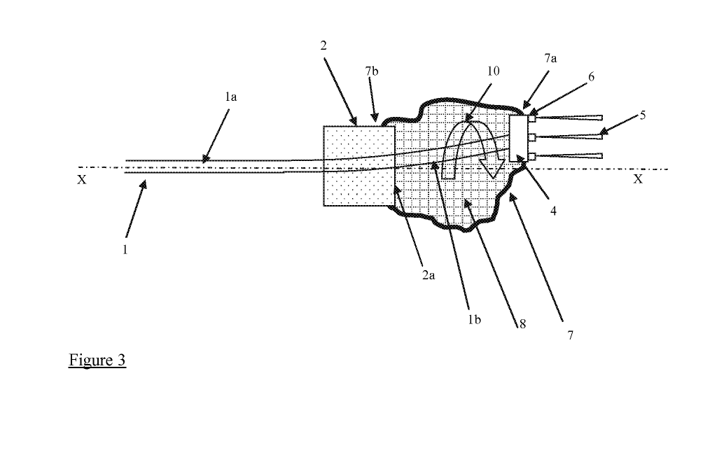

FIG. 3 schematically depicts a device according to one particular embodiment of the invention.

As can be seen in FIG. 1, the jet or jets 5 of cryogenic fluid are distributed in the conventional way by one or more fluid distribution nozzles 6 arranged on a nozzle bearing tool 4 given a determined, typically oscillatory or rotary, movement (arrow 10).

The nozzle bearing tool 4 is fluidically connected to the downstream end of a cryogenic fluid supply pipe 1, itself fluidically connected to a source of cryogenic fluid situated upstream of said pipe (and not depicted).

The pipe 1 comprises an upstream portion 1a and a downstream portion 1b. During performance of the scouring or descaling method using jets 5 of cryogenic fluid the downstream portion 1b supporting the downstream end of the cryogenic supply pipe 1 and the nozzle-bearing tool are given the determined movement about the axis XX of the fixed upstream portion 1a of the pipe 1.

In order to do that, a movement system 2 that moves the nozzle bearing tool 4 is arranged between the upstream portion 1a and the downstream portion 1b of pipe 1 and acts on said downstream portion 1b in order to confer said determined movement upon it.

Typically, the movement system 2 that moves the nozzle-bearing tool 4 comprises a motor collaborating with the fluid supply pipe 1 via a rotary transmission shaft and a rotation mechanism (neither illustrated) as proposed in document WO-A-2011/010030. The rotation mechanism comprises movement means acting on the downstream portion 1b of pipe so as to confer upon it a determined movement, of whatever type that might be, particularly a rotational or oscillatory movement. A rotational movement will be understood to denote a movement that describes a circle.

Because of the movement that needs to be conferred upon the downstream portion, it will be understood that it is essential that the movement of the downstream portion of the pipe and of the nozzle-bearing tool should not be impeded.

As already explained, during the operation of scouring or descaling the surface of a material, particles of material that have been scoured or scaled off and that have a hardness higher than that of the movement system 2 and the constituent elements thereof find themselves blasted toward the movement system 2, particularly toward the front face 2a of said system 2 that faces the treated surface of the material.

In the case of a method for scouring concrete, the blasted particles are made up of aggregate that has been cut or broken and of cement that has been pulverized under the effect of the jets of high-pressure fluid at cryogenic temperature. The impact of the pieces of aggregate causes accelerated erosion of and damage to the movement system 2 and the constituent elements thereof.

The effect of the aggregate is particularly harmful on the side of the front face 2a of the system 2 which is generally completely or partially open and directly exposes constituent elements of the system 2 to blasted aggregate and/or dust.

To remedy that and protect the movement system 2, at least one flexible protection casing 7 is, according to the present invention, arranged around all or part of the movement system 2 that moves said nozzle bearing tool 4.

Said casing 7 may also be arranged around all or part of the downstream portion 1b of pipe 1 and/or around the nozzle bearing tool 4.

Depending on circumstance, the device according to the invention may comprise a single flexible casing 7 or several flexible casings 7 superposed on one another and/or placed end to end.

In all events, once the casing 7 has become worn, only said casing 7 need be changed, and this is markedly less expensive than changing one or more damaged components of the rotation system 2 or the system 2 itself.

In one embodiment of the invention, illustrated in FIG. 2, a flexible protection casing 7 forms a deformable sleeve around all or part of the nozzle bearing tool 4, the movement system 2 that moves said nozzle-bearing tool 4 and the downstream portion 1b of pipe 1. Thus the risk of aggregate and/or dust entering the movement system 2 is greatly, or even completely, reduced.

For preference, the flexible protection casing 7 comprises a first open end 7a situated level with the nozzle bearing tool 4 and a second open end 7b situated level with the movement system 2 that moves said nozzle bearing tool 4. The first end 7a may also be situated level with the downstream portion 1b of pipe 1.

Furthermore, the device of the invention advantageously comprises securing rings for fixing the first end 7a of the at least one casing 7 to the nozzle bearing tool 4 or to the downstream portion 1b of pipe 1 and for fixing the second end 7b of the at least one casing 7 to the movement system 2 that moves said nozzle bearing tool 4 or to the downstream portion 1b of pipe 1.

For preference, the second end 7b of the at least one casing 7 is fixed to the movement system 2 so as to afford protection to the front face 2a of the system 2.

What is meant by securing means is any means that allows the casing 7 to be fixed or, in other words, fastened or assembled, on the nozzle bearing tool 4, the downstream portion 1b of pipe 1 or the movement system 2. These securing means may for example comprise at least one collar and/or flange, possibly combined with one or more screws.

Said securing means preferably allow the flexible protection casing 7 to be detached, advantageously easily, so that it can easily be replaced if it becomes excessively worn.

According to the invention, the casing 7 has the flexibility needed so that it does not impede, particularly disturb, hamper or slow down, the movement of the downstream portion of pipe 1b and of the nozzle bearing tool 4.

According to one preferred embodiment of the invention, illustrated in FIG. 3, the device of the invention comprises at least one flexible protection casing 7 comprising a network of interlaced links forming chain-mail.

According to another embodiment, the device of the invention comprises at least one flexible protection casing 7 comprising interlaced filaments, i.e. a weave of filaments, forming a flexible fabric.

Advantageously, the protection casing 7 is fixed to at least part of the peripheral wall of the movement system 2 that moves the nozzle holding tool 4 and to at least part of the peripheral wall and/or the face of said nozzle holding tool 4 that supports the nozzle 6, as illustrated in FIG. 2.

The second end 7b of the protection casing 7 may also be fixed to the front face 2a of the movement system 2 that moves the nozzle holding tool 4.

Advantageously, the flexible protection casing 7 is formed completely or partially of a material having a hardness of at least 7 Mohs, preferably of at least 8 Mohs.

For preference, the casing 7 is formed completely or partially from the metallic material, preferably stainless steel because of its good cold properties, and more preferably still, stainless steel of type 316L.

As an alternative, the casing 7 may be formed completely or partially of titanium or of carbon fiber.

The casing 7 may also be formed completely or partially from a non-metallic material, which may or may not be composite, for example a material formed of ceramic composite fibers.

By using a casing 7 formed of interlaced links or filaments, the casing 7 produced is deformable, i.e. the casing 7 has the flexibility necessary for correct operation of the movement system that moves the nozzle holding tool, while at the same time retaining the possibility of using links or filaments made of a material with high hardness, typically higher than the hardness of the materials being blasted, for example from 6 to 8 Mohs in the case of concrete aggregate, and good resistance to cryogenic temperatures, namely to temperatures of below −100° C., preferably of between −130° C. and −160° C.

When the casing 7 is made of chain-mail or a weave of filaments, the spaces between the interlaced links or filaments of the woven form passage orifices placing the inside and the outside of the casing 7 in fluidic communication. Particles of dimensions smaller than the dimensions of the orifices of the casing 7 can therefore pass through this casing and potentially damage the movement system 2 and the constituent elements thereof. The largest particles most significantly damage the hardware at the moment of impact.

These orifices need to be small enough in size that they prevent the particles blasted during the scouring or descaling operation from passing through the casing 7, or at least so that said particles are slowed by impact with the links of the casing 7, the purpose of this being to greatly reduce, if not eliminate, the destructive effect of said particles even if these particles do pass through the casing 7.

Thus, the dimensions of the passage orifices are advantageously tailored to offer a good compromise between the flexibility of the casing 7 and the effectiveness at blocking and/or slowing the most damaging particles coming from the scoured or descaled surface.

This compromise is notably dependent on the characteristic sizes or dimensions of the particles of material blasted during implementation of the method.

In order to estimate the most advantageous dimensions for the orifices of the casing 7, notably in the context of a method using jets of cryogenic fluid to descale concrete, the inventors of the present invention have carried out a method of descaling a concrete surface measuring of the order of 100×50 cm using jets of liquid nitrogen at a typical temperature of −140° C. and a pressure of the order of 3500 bar.

The scaled-off concrete was collected by an extraction system. It was thus possible to measure the resultant particle size distribution. The table below gives the particle size distribution of particles of between 0.2 and 2.5 mm, expressed as a percentage of the mass of particles generated during the operation of scouring the concrete.

TABLE

| Dimensions of | | % of mass of particles |
|---|---|---|
| screen mesh | | recovered |
| 2.5 | mm | 19 |
| 2 | mm | 4 |
| 1.6 | mm | 3 |
| 1.25 | mm | 4.5 |
| 1 | mm | 3.5 |
| 0.8 | mm | 4 |
| 0.5 | mm | 5 |
| 0.4 | mm | 4 |
| 0.315 | mm | 5 |
| 0.25 | mm | 5 |
| 0.2 | mm | 4 |
| Less than 0.2 | mm | 39 |

In the light of this table it may be seen that 34% of the total mass comes from particles the dimensions of which are in excess of 1 mm. In addition, these largest particles will have the most damaging effects when they impact on the constituent elements of the movement system, particularly the mechanisms of said tool. Furthermore, these are predominantly particles originating from the destruction of aggregate and therefore materials of high hardness, which means to say of the order of 6 to 8 Mohs.

Advantageously, the orifices of the flexible casing 7 will therefore have dimensions smaller than 2 mm, preferably smaller than 1 mm. The terms “orifice dimensions” means the dimensions of the orifices in all directions of the plane containing each orifice, for example the width, the length and the diagonal of the orifices.

For preference, when the at least one casing 7 is chain-mail, the links have the same shape and size, preferably being annular or oval in shape. Advantageously, the at least one casing 7 is chain-mail with outside dimensions of between 3 and 4 mm and inside dimensions of between 2 and 3 mm. The thickness of the links is preferably of the order of 0.3 to 0.7 mm. With such a casing, the passage orifices formed have dimensions typically smaller than 2 mm, or even smaller than 1 mm, particularly when the chain-mail according to the invention is not perfectly stretched out, as it is when fitted to the fluid jet distribution device of the invention.

In order artificially to reduce the dimensions of the orifices of the casing 7, several chain-mails or filament weaves may be superposed on one another. For preference, the number of superpositions will be limited to three or four casings 7 in order not to excessively stiffen or weigh down the protective device according to the invention and impede the operation of the cryogenic fluid jet distribution device of the invention.

It should be noted that, according to circumstance, the superposed casings may be formed of several chain-mails only or of several weaves only or alternatively of at least one chain-mail and at least one weave that have been superposed.

Furthermore, in the light of the table above, it may be seen that a significant proportion of the recovered total mass comes from particles the dimensions of which are smaller than 0.2 mm. In the context of a concrete descaling method, these particles are typically formed of cement dust. These fine particles notably foul the mechanisms of the movement system 2, such as the gears, and contribute to the wearing of the mechanical components of said movement system 2.

In order to prevent this dust from entering the movement system 2, one particular embodiment of the invention, visible in FIG. 3, is a device for dispensing one or more jets of cryogenic fluid comprising one or more flexible protection casings 7, preferably one or more chain-mails 7. This device further comprises a woven or nonwoven material 8, for example stainless steel wool, arranged in bulk, i.e. arranged so as to fill the space left free, between the casing 7, the movement system 2 and the portion of pipe 1b. The material 8 then acts as an additional filter to prevent the finest dust particles from entering the movement system 2, particularly via the front face 2a.

Moreover, the solution of the invention also relates to a method for scouring or descaling a surface that is to be treated using one or more jets 5 of high-pressure fluid at cryogenic temperature which are distributed by means of a device according to the invention.

For preference, the working method of the invention employs one or more jets 5 of high-pressure fluid at cryogenic temperature, said jets being at a pressure of at least 300 bar, preferably a pressure of between 1000 and 5000 bar, and at a temperature of below −100° C., preferably a temperature of between −130° C. and −160° C.

The cryogenic fluid used is advantageously liquid nitrogen.

The present invention is particularly advantageous for methods of descaling a concrete surface because it effectively protects the movement system that moves the nozzle bearing tool from the pieces of aggregate and/or dust that are blasted, without disrupting the movement conferred on the nozzle bearing tool.

1-15. (canceled)

16. A device for dispensing one or more jets of high-pressure fluid at cryogenic temperature, comprising a nozzle-bearing tool comprising one or more fluid distribution nozzles, and a movement system for moving said nozzle bearing tool, further comprising at least one flexible protection casing arranged around all or part of the movement system that moves said nozzle bearing tool.

17. The device as claimed in claim 16, wherein the flexible protection casing is also arranged around the nozzle bearing tool.

18. The device as claimed claim 16, further comprising a fluid supply pipe comprising an upstream portion of an axis (XX) and a downstream portion fluidically connected to the nozzle bearing tool, the movement system that moves the nozzle bearing tool being arranged between the upstream portion and the downstream portion of pipe and acting on said downstream portion so as to confer upon it a determined movement about the axis (XX).

19. The device as claimed in claim 18, wherein the at least one flexible protection casing is also arranged around all or part of the downstream portion of pipe.

20. The device as claimed in claim 18, wherein the at least one flexible protection casing comprises a first open end situated level with the nozzle bearing tool or with the downstream portion of pipe and a second open end situated level with the movement system that moves said nozzle bearing tool or with the downstream portion of pipe.

21. The device as claimed in claim 19, further comprising securing means that fix the first end of the at least one flexible protection casing to the nozzle bearing tool or to the downstream portion of pipe and that fix the second end of the at least one protection casing to the movement system that moves said nozzle bearing tool or to the downstream portion of pipe, said securing means allowing at least one end of the flexible protection casing to be detached.

22. The device as claimed in claim 16, further comprising several superposed flexible protection casings.

23. The device as claimed in claim 16, further comprising at least one flexible protection casing that comprises a network of interlaced links forming chain-mail.

24. The device as claimed in claim 23, wherein the links are of annular or oval shape, with external dimensions of between 3 and 4 mm and inside dimensions of between 2 and 3 mm.

25. The device as claimed in claim 16, further comprising at least one flexible protection casing comprising a weave of filaments.

26. The device as claimed in claim 16, wherein said at least one flexible protection casing is formed completely or partly of a material that has a hardness of at least 7 Mohs.

27. The device as claimed in claim 16, wherein a woven or nonwoven material is arranged in bulk between the flexible protective sleeve, the movement system and the downstream portion of pipe.

28. A method for scouring or de-scaling a surface that is to be treated, employing one or more jets of high-pressure fluid at cryogenic temperature which are distributed by means of a device as claimed in claim 16.

29. The method as claimed in claim 28, wherein the jet or jets of high-pressure fluid at cryogenic temperature are at a pressure of at least 300 bar, and at a temperature of below −100° C.

30. The method as claimed in claim 28, wherein the fluid employed is liquid nitrogen.
